(19) United States
(12) Patent Application Publication
(10) Pub. No.: US 2024/0402084 A1
(43) Pub. Date: Dec. 5, 2024

(54) MEASUREMENT OF PHOTOLUMINESCENCE IN A DROPLET

(71) Applicants: Norman McMillan, County Carlow (IE); Advanced Nano Technologies Limited, Dublin (IE)

(72) Inventors: Norman McMillan, County Carlow (IE); Martina O'Neill, Dublin (IE); Stephen Smith, Colchester Essex (GB)

(21) Appl. No.: 18/697,021

(22) PCT Filed: Sep. 30, 2022
(86) PCT No.: PCT/EP2022/077417

§ 371 Date: Mar. 29, 2024

(30) Foreign Application Priority Data
Sep. 30, 2021 (GB) 2114066.0

(51) Int. Cl. G01N 21/64

(52) U.S. Cl. CPC G01N 21/645; G01N 2021/6463; G01N 2021/6484; G01N 2201/0636

(57) ABSTRACT

A system for measuring the photoluminescence in a droplet provides a source of light for exciting photoluminescence in a liquid, a stop positioned relative to the source so as to define a shadow zone in which excitation light from the source is blocked from direct transmission by the stop, and a sample-receiving region in the shadow zone. A redirection system positioned outside the shadow zone receives excitation light from the source and redirects the light towards the sample-receiving region inside the shadow zone. A detector, which is shielded from the excitation light by the stop, is positioned to receive photoluminescent radiation emanating from a droplet in the sample-receiving region. The redirection system extends around the shadow zone to redirect light into the sample-receiving region from a plurality of converging directions. This maximizes the illumination of the drop while shielding the detector from direct illumination from the source.

### TECHNICAL FIELD

This invention relates to the measurement of photoluminescence in a droplet, and to devices, systems and methods for use in such measurement. The invention has application in fluorescent, phosphorescent and Raman emission measurements as well as any other applications where light is emitted from a sample as a result of absorbed photons.

### BACKGROUND ART

Fluorescence can be studied using a range of spectroscopic tools. There are several molecular modalities for analysing drop and microvolume samples, but fluorescence has been probably the most widely used as it is a technique based on a very useful arbitrary scale of photometric emission intensity, and it does not depend on fundamental theoretical relationships such as the Beer-Lambert law used in UV-visible spectrophotometry. An advantage of fluorescence over older and more widely used UV-visible techniques is that the pathlength of the measurement does not need to be known as the scale is ‘arbitrary’ but nevertheless is quantitatively defined in terms of the instrumental setup.

Two general types of fluorescence measurement instruments exist: (1) filter fluorometers use filters to isolate the incident light and fluorescent light; and (2) spectrophotometers use diffraction grating monochromators to isolate the incident light and fluorescent light.

Both types use the following general scheme. The light from an excitation source passes through a filter or monochromator, and strikes the sample. A proportion of the incident light is absorbed by the sample, and some of the molecules in the sample fluoresce. The fluorescent light is emitted in all directions. Some of this fluorescent light passes through a second filter or monochromator and reaches a detector.

Various light sources may be used as excitation sources, including lasers, photodiodes, and lamps; xenon arcs and mercury-vapour lamps in particular. A laser only emits light of high irradiance at a very narrow wavelength interval, typically under 0.01 nm, which makes an excitation monochromator or filter unnecessary. The disadvantage of this method is that the wavelength of a laser usually cannot be changed by much. A mercury-vapour lamp is a line lamp, meaning it emits light near peak wavelengths. By contrast, a xenon arc has a continuous emission spectrum with nearly constant intensity in the range from 300-800 nm and a sufficient irradiance for measurements down to just above 200 nm.

The detector can be single-channelled or multi-channelled. Single-channelled detectors can only detect the intensity of one wavelength at a time, while multi-channelled detectors detect all wavelengths simultaneously, making the emission monochromator or filter unnecessary. The different types of detectors have different advantages and disadvantages.

The most versatile fluorimeters with dual monochromators and a continuous excitation light source can record both an excitation spectrum and a fluorescence spectrum. When measuring fluorescence spectra, the wavelength of the excitation light is kept constant, preferably at a wavelength of high absorption, and the emission monochromator scans the spectrum. For measuring excitation spectra, the wavelength passing though the emission filter or monochromator is kept constant and the excitation monochromator is scanning. The excitation spectrum generally is identical to the absorption spectrum as the fluorescence intensity is proportional to the absorption. There are numerous combinations and variations on these basic instrumental set-ups.

Interest is increasing in the measurement of properties of liquids by studying the interaction of light with a fixed-volume droplet rather than bulk spectroscopy. A number of examples of such droplet-based micro volume analysis arrangements are disclosed in WO 2007/031945. A stand-alone instrument is described in Applicant's unpublished EP application Ser. No. 11/162,343.5.

The above-mentioned droplet-based systems involve the transmission of light between a source and a detector through a droplet of liquid. Because the droplets are small (typically less than 10 microlitres, more usually in the 0.5 to 5 microlitre range) any repeatable volume deposits under the drophead will be constrained by dominant surface tension forces to the same repeatable shape (surface tension being much greater than the distorting gravitational force in small volume), and thus the coupling of light or the reflection of light inside the droplet will be reproducible due to the reproducible shape of the drop. This means that any differences in observed spectrum are due necessarily to the inherent liquid characteristics, not to changes in dimensions or drop shapes. Reproducibility of drop shape means that the integral path length (a factor in Beer's Law calculations) is potentially more accurate than other systems.

When measuring photoluminescence effects, in particular fluorescence, phosphorescence, and Raman emissions, an instrument will typically be arranged such that the detector is placed at about 90 degrees to the incident light beam to minimise the risk of transmitted or reflected incident light reaching the detector. If the source, sample and detector were placed in a straight line, the detector would be overwhelmed by the excitation light, and in many cases the signal-to-noise ratio (i.e. the emitted fluorescence or phosphorescence signal relative to the excitation light noise) would be unacceptably low. While monochromators and filters can help isolate the excitation and fluorescence wavelengths from one another, such components are not perfect and there is a certain amount of leakage. By arranging the source and detector along paths which are at 90 degrees to one another, one can typically lower the detection limit by a factor of approximately 10,000 when compared to a straight-line geometry.

For this reason, spectrofluorometers are designed with this 90-degree geometry in mind. For the same reason, straight-line microvolume analysis systems are unsuitable for fluorescence measurements.

### DISCLOSURE OF THE INVENTION

The invention provides a system for measuring the photoluminescence in a droplet, comprising:
a source of light for exciting photoluminescence in a liquid, said source being located at a first position;
a stop positioned relative to the source so as to define a shadow zone in which light of at least one wavelength emanating from the source is blocked from direct transmission by the stop, said shadow zone including a sample-receiving region;
a redirection system comprising at least one redirecting element positioned outside said shadow zone, wherein said redirecting element is adapted to receive light from said source and to redirect said received light towards said sample-receiving region inside the zone; and
a detector receiving, at a second position, photoluminescent radiation emanating from said sample-receiving region;
wherein said redirection system extends around the zone to redirect light into the sample-receiving region from a plurality of converging directions, such that said region receives light from said plurality of converging directions.

Preferably, said plurality of converging directions encompass in aggregate a combined angular extent of at least 90 degrees, and preferably at least 180 degrees.

Preferably, said redirection system includes one or more redirecting elements that are disposed on substantially all sides of the shadow zone, and which illuminate the sample-receiving region from substantially all sides simultaneously.

Preferably, said at least one redirecting element is a reflective surface.

Alternatively, said at least one redirecting element is a refractive element.

Preferably, the system further comprises a drop-supporting surface located at said sample-receiving region, said drop-supporting surface being adapted to receive and retain thereon a sample in the form of a liquid drop.

Preferably, the detector is shielded from direct illumination by the source.

Preferably, the detector is shielded due to said second position being in said shadow zone.

Preferably, the detector is shielded due to receiving illumination via a wave guide which receives light at said second position from a predetermined range of angles, wherein said source is not in a direct line of sight within said range of angles.

Preferably, the wave guide is an optical fiber.

Preferably, the source, the sample-receiving region and the stop are located along a common axis with the stop being located between the source and the sample-receiving region.

Preferably, the second position is located along said common axis with the sample-receiving region being located between the second position and the stop.

Alternatively, said second position is between the stop and the sample-receiving region.

Preferably in such cases, said second position is directly behind the stop and in the shadow thereof.

Preferably, the detector is shielded against illumination by light from the source both along a direct path and along an indirect path via the redirection system.

Preferably, with the stop being located between the source and the sample-receiving region, the stop and the redirection system constrain the light travelling between the first position and the sample-receiving region to an indirect path and cause light to enter the sample-receiving region at a non-zero angle to said axis, thereby preventing the direct transmission of light from the source to the detector via the droplet.

Preferably, the light is caused to enter the sample-receiving region at an angle of more than 45 degrees to said axis.

Preferably, the light is caused to enter the sample-receiving region at an angle of between 70 and 110 degrees to said axis.

Preferably, the light is caused to enter the sample-receiving region at said non-zero angle to said axis from a range of different lateral directions around said axis, and preferably from substantially all lateral directions simultaneously.

Preferably, in some embodiments, said redirection system is adapted to focus the incident light at the sample-receiving region in a concentrated focus within the volume of a sample, whereby relative movement of one or more of the sample, the redirection system, the source, or an optical element located in the indirect path between the source and the sample via the redirection system, causes the concentrated focus to move within the sample to optimise the photoluminescent signal from the sample.

Preferably, in some embodiments, said redirection system is adapted to focus the incident light such that at the sample-receiving region the incident light is spread across a diffuse focus area intersecting the majority of the sample volume.

In particularly preferred embodiments, these modes are combined, wherein relative movement between the source and the redirection system, or the adjustment of an optical element in the path of the incident light, causes the focus to switch from a concentrated focus to a diffuse focus.

Preferably, the redirection system is configurable between a first configuration providing a concentrated focus and a second configuration providing a diffuse focus.

Preferably, the activation of a second source, provided at a different position relative to the redirection system than said source, causes the focus to switch between a diffuse focus and a concentrated focus.

Preferably the system further comprises one or more further sources, located at different position(s) than said source or said second source, which when activated cause the focus to switch to one of a concentrated focus in a different position within the sample-receiving region and a diffuse focus with different spatial characteristics than provided by either said source or said second source.

Preferably, the redirection system in combination with the source or sources is effective to bring the incident light to a focus that is intermediate between a concentrated point-like focus and a diffuse focus extending through the volume of a sample at the sample-receiving region.

Preferably, the system further comprises a sample-receiving surface for receiving a sample at the sample-receiving region; a positioning system for controllably causing relative movement between one or more of the sample-receiving surface, the redirection system, the source, and an optical element in the path of the incident light; and a controller for operating the positioning system to achieve a desired focussing of the incident light at the sample-receiving region.

Preferably, said controller receives as an input a signal from the detector, whereby an optimal position may be identified according to the characteristics of the detector signal.

Preferably, the system further comprises an imaging system for imaging said sample-receiving region.

Preferably, said imaging system comprises a camera.

Preferably, said imaging system is provided with protection against overexposure from the source.

Preferably, said protection is selected from a filter that attenuates light of a wavelength emitted by the source and an electronically controlled shutter that is timed to the excitation of the source.

Preferably, the system further comprises a computerised system programmed to calculate, from an image provided by the imaging system, one or more dimensional characteristics of the sample, and to normalise a photoluminescence measurement according to the said one or more dimensional characteristics and a signal from the detector.

Preferably, the system further comprises a support body having a hollow cavity having an opening and having said at least one redirecting element on the interior thereof, said source being mounted in said cavity to illuminate the redirecting element and said stop being mounted internally of the cavity to block at least a portion of the light from said source from travelling towards the opening, whereby a sample may be introduced at or within the opening to receive redirected illumination from the at least one redirecting element.

Preferably, the system further comprises a support base having a sample-receiving surface defined thereon within the shadow zone, and having said redirecting element of said redirection system provided as a circumferential redirecting element at least partially surrounding the sample-receiving surface, wherein said circumferential redirecting element is shaped to redirect light received from said source to a sample-receiving region adjacent the sample-receiving surface, such that when a sample in the form of a drop is placed on the sample-receiving surface it is illuminated with said redirected light.

Preferably, the frequency characteristics of the illumination from the source or sources are controllable.

Preferably, the frequency characteristics can be controlled to vary the photoluminescent response of different species in a sample.

Preferably, said source comprises a plurality of sources each with different frequency characteristics, which may be activated and deactivated independently, or mixed together, or activated with different intensities.

### BRIEF DESCRIPTION OF THE DRAWINGS

The invention will now be further illustrated by the following description of embodiments thereof, given by way of example only, with reference to the accompanying drawings in which:

FIG. 1 is a cross-sectional elevation through a first embodiment for measuring photoluminescence in a droplet;

FIG. 2 is a cross section through the body of FIG. 1;

FIG. 3 is a plan view thereof from above;

FIG. 4 is a plan view thereof from below;

FIG. 5 is a side elevation thereof;

FIG. 6 is a cross section of the sample base of FIG. 1;

FIG. 7 is a plan view thereof from above;

FIG. 8 is a plan view thereof from below;

FIG. 9 is a side elevation thereof;

FIG. 10 is a cross section of the quartz plate and stop of FIG. 1;

FIG. 11 is a plan view thereof from above;

FIG. 12 is a plan view thereof from below;

FIG. 13 is a side elevation thereof;

FIG. 14 is a cross-sectional elevation through a second embodiment for measuring photoluminescence in a droplet;

FIG. 15 is a cross-sectional elevation through a third embodiment for measuring photoluminescence in a droplet;

FIG. 16 is a cross-sectional elevation through a fourth embodiment for measuring photoluminescence in a droplet;

FIG. 17 is a cross-sectional elevation through a fifth embodiment for measuring photoluminescence in a droplet;

FIG. 18 is a cross-sectional elevation through a sixth embodiment for measuring photoluminescence in a droplet;

FIG. 19 is a cross-sectional elevation through a seventh embodiment for measuring photoluminescence in a droplet;

FIGS. 20 and 21 illustrate different modes for illumination of a droplet in the systems for measuring photoluminescence in a droplet;

FIG. 22 is a cross-sectional elevation through an eighth embodiment for measuring photoluminescence in a droplet, shown in two illumination modes; and

FIG. 23 is a schematic illustration of a ninth embodiment for measuring photoluminescence in a droplet.

### DETAILED DESCRIPTION OF PREFERRED EMBODIMENTS

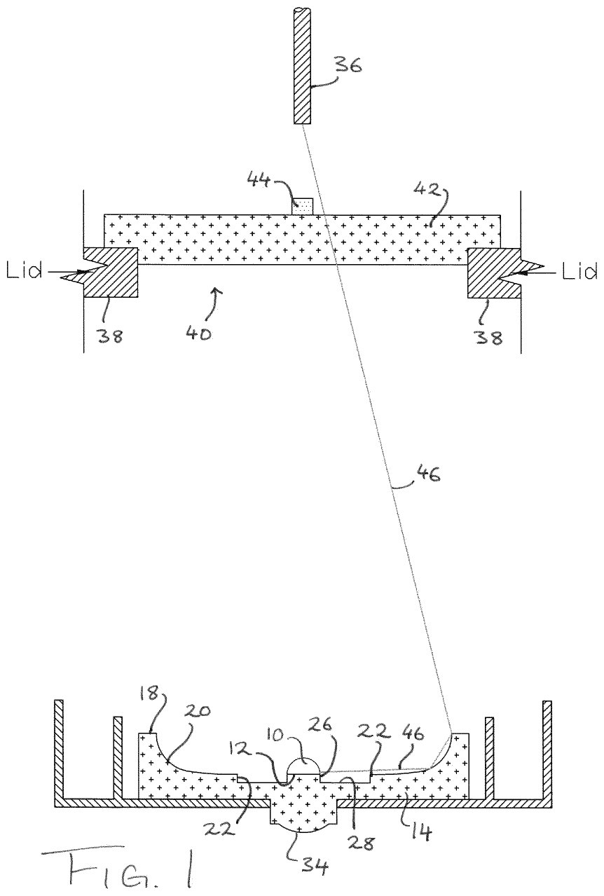

FIG. 1 shows a first embodiment of the system for measuring photoluminescence in a droplet 10 provided on a drop supporting surface 12 of a body 14.

The body 14 is transmissive of light and is preferably made of quartz. The body is shown positioned within a plastic base 16 which may form part of a spectrophotometer and which will be described in greater detail below.

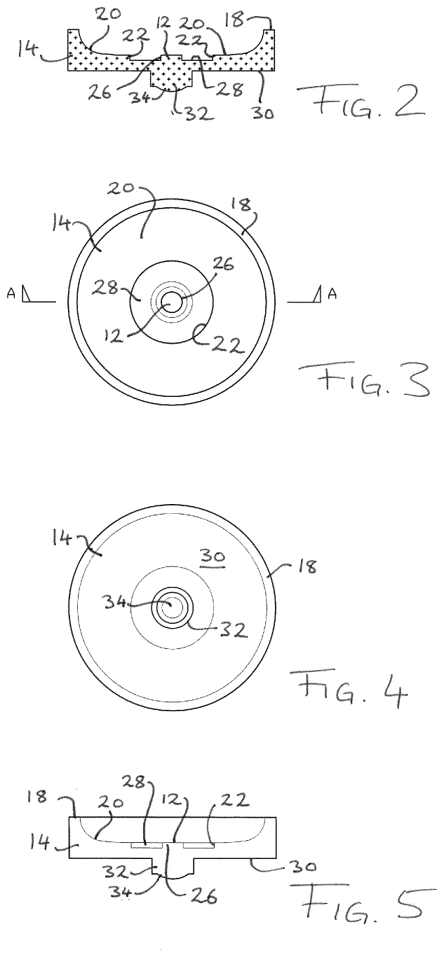

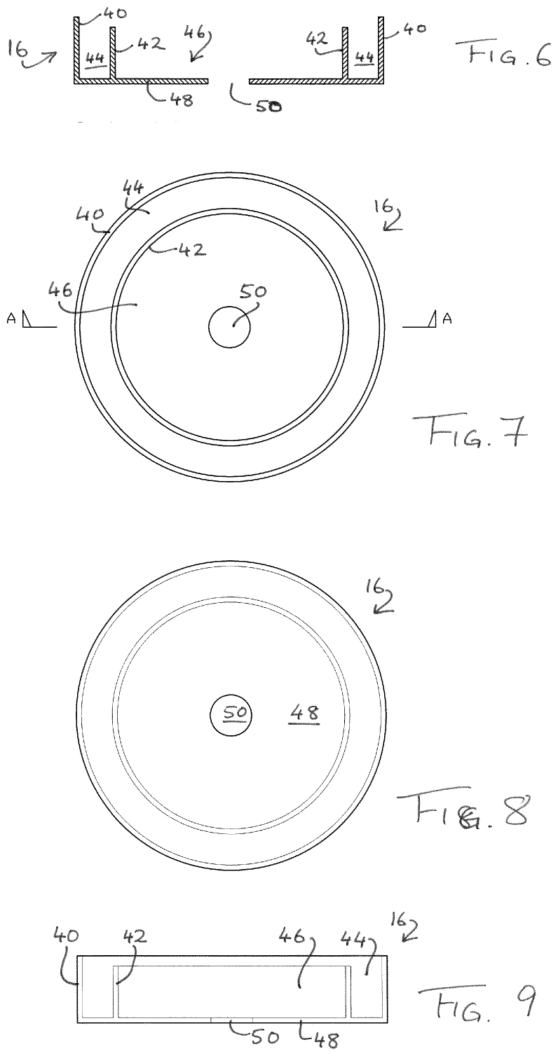

Referring additionally to FIGS. 2-5, in which the body is shown respectively in cross section (FIG. 2, taken along the line II-II of FIG. 3), from above (FIG. 3), from below (FIG. 4) and in side elevation (FIG. 5), it can be seen that the body 14 is generally in the form of a disc having a raised outer rim 18, and having an inwardly and downwardly curved, annular upper surface 20 which slopes downwards from rim 18 to a circular inner step 22. The drop-supporting surface 12 is defined as the top disc surface of a central plinth 26, with an annular well 28 defined between the plinth 26 and step 22. This drop-supporting surface (or sample-receiving surface as also described herein) defines a sample-receiving region, which is the region or volume of space occupied by droplet 10 when positioned so that it occupies the surface 12, where it is held by surface tension.

The curved annular surface 20 is mirrored, and the shape of the curve is calculated to collect light falling on this surface, from a predefined source position, and to focus it on a droplet sitting on the plinth, as will be described in more detail below.

The base of the body 14 takes the form of a generally flat disc surface 30 having a central protrusion 32 terminating at a focussing surface 34. The central protrusion 32 assists in positioning and seating the body 14 within the plastic support 16 (FIG. 1). In use a detector (not shown) such as a charge coupled device, will be located below the focussing surface 34.

Referring back to FIG. 1, a source fibre 36 is positioned in a direct line above the droplet 12, normal to the base of the disc body. In use the fibre will be mounted using a suitable mounting arrangement to a lid 38 of a spectrophotometer. The mounting arrangement is not shown and any suitable mounting may be used to hold the fibre or other light source in place.

A circular aperture 40 in the lid 38 is covered by a quartz plate 42 which is transmissive of light at the wavelength chosen to excite photoluminescence in the droplet 10. Positioned centrally on the plate 42 is a stop 44 which is opaque to this radiation and thereby block the direct transmission of light from the source to the droplet. As indicated by an exemplary ray path 46, the curved mirrored surface 20 is adapted to receive light which bypasses the stop and hits the curved mirrored surface 20, and is shaped to reflect the light into the droplet 12, thereby coupling light indirectly from the source to the droplet. Reflections can be single reflections or (as shown for ray 46) multiple reflections.

While only a single ray 46 is shown, it will be appreciated that the shape of the curved surface is designed to maximise the capture of light and to optimally reflect that light into the droplet based on the geometry of the system. Furthermore, in the embodiment illustrated, the curved surface 20 extends annularly around the droplet and thus light is collected from all sides and focussed centrally into the droplet. However, simpler shapes may be employed using a single mirror or a number of discrete mirrors, rather than a complex curved silvered surface, to focus some incident light into the droplet. It will be appreciated that while an annular arrangement illuminates the droplet from a 360 degree range of positions, the benefit can be achieved even where the range of angles is not continuous throughout a 360 degree range, and illumination from several sides, or preferably from substantially all sides, can achieve comparable benefits in terms of increasing the illumination into the droplet. Thus for example, a set of e.g. 4 refractive or reflective elements, each redirecting the illumination from a different quadrant, would provide improved illumination. Other arrangements will suggest themselves to the skilled person.

As one will appreciate, the droplet is thereby excited with light and, subject to the photoluminescent properties of the liquid and the wavelength and intensity of incident light, phenomena such as fluorescence and phosphorescence result in the generation of photons within the droplet. Such photoluminescent photons will typically be emitted in all directions, so that a reasonable portion will be emitted downwards into the transparent protrusion 32 and will be focussed onto the detector positioned below the droplet.

The photoluminescent response can be modulated according to the characteristics of the incident illumination, such as for example if there are different species with different fluorescent responses. It may be possible to excite these species selectively according to the wavelengths of the incident illumination, and thereby measure individual species or measure all species at once. For example, fluorescent dyes absorb light over a range of wavelengths, and every dye has a characteristic excitation range. However, typically some wavelengths within that range will be more effective for excitation than others. The range of incident wavelengths reflects the range of possible excited states that the fluorophore can achieve. So for each fluorescent dye, there is a specific wavelength—the excitation maximum—that most effectively induces fluorescence. By choosing appropriate illumination sources, and by combining sources or modulating the incident wavelengths, selective excitation may be achieved.

It will be appreciated that the assembly shown in FIG. 1 can be retrofitted to a device which is adapted to receive the plastic base 16 and which has a straight-line geometry. Examples of such an instrument are illustrated further below.

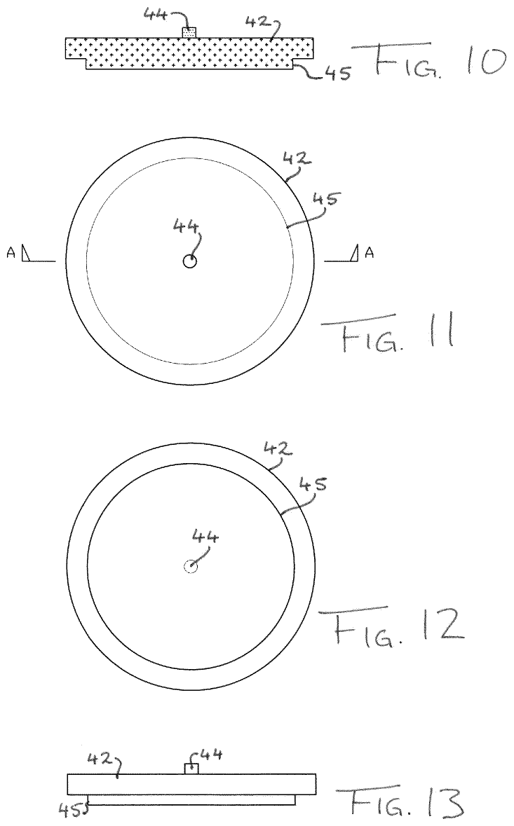

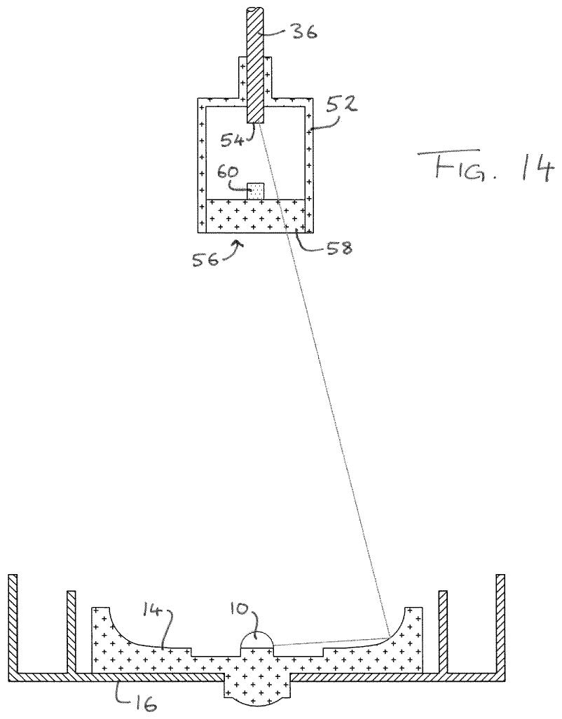

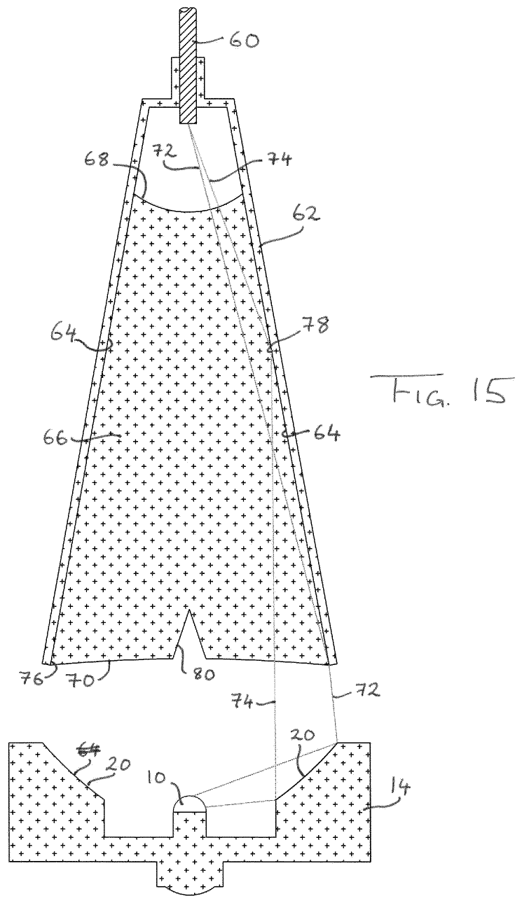

FIGS. 6, 7, 8 and 9 show the plastic base 16 respectively in cross section (FIG. 6, taken along the line VI-VI shown in FIG. 7), from above (FIG. 7), from below (FIG. 8) and in side elevation (FIG. 9). It can be seen that there is an outer wall 40, an inner wall 42 and an annular space 44 between these walls. Within the inner wall 42 a circular space 46 is defined above a base 48 having a central hole 50. This space 46 accommodates the body 14 as shown in FIG. 1, with the hole 50 permitting the central protrusion of the body 14 to pass through. The annular space may hold a liquid to provide a reservoir. If the assembly of the base and the body are held in a confined space, then the reservoir can saturate the space with vapour to inhibit the evaporation of solvent or liquid from the drop 10.

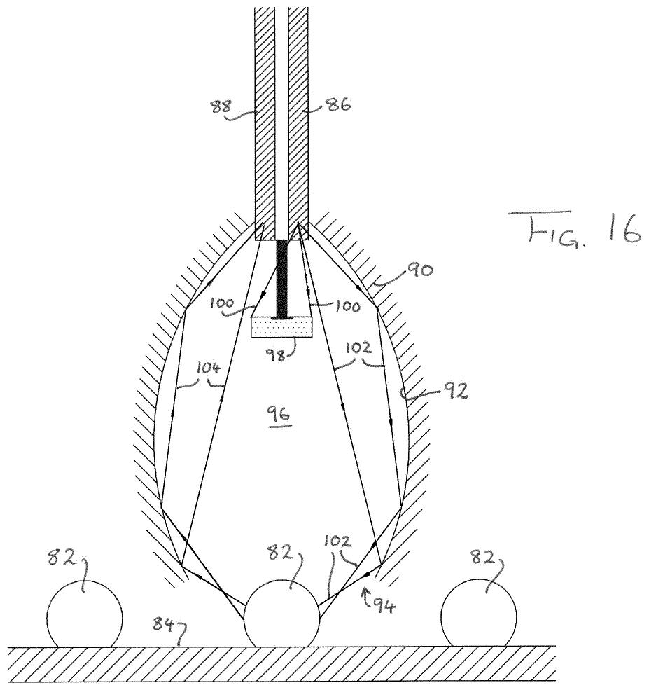

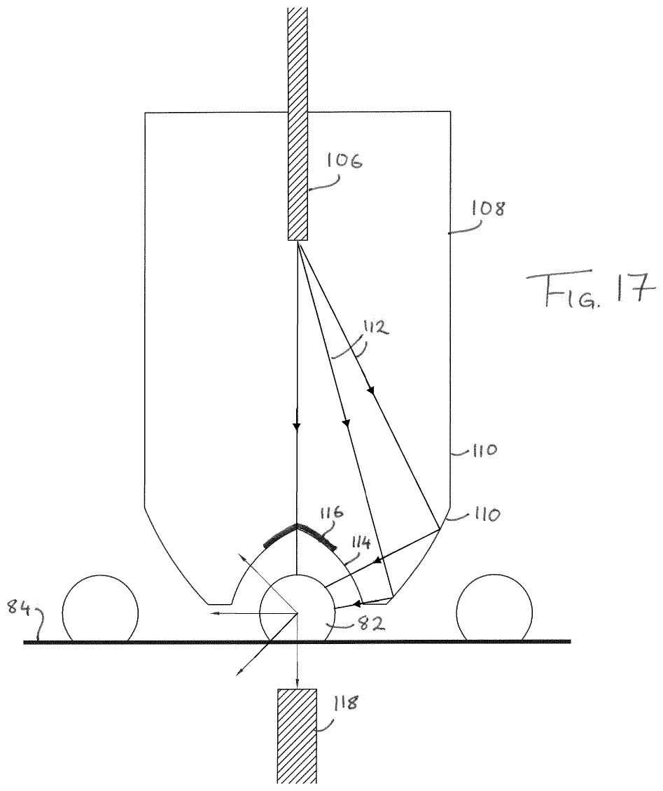

FIGS. 10, 11, 12 and 13 similarly show the quartz plate 42 and stop 44 respectively in cross section (FIG. 10, taken along the line A-A shown in FIG. 11), from above (FIG. 11), from below (FIG. 12), and in side elevation (FIG. 13). It can be seen that on the underside of the quartz plate 42 there is a step 45 used to position the plate 42 on the lid 38 (FIG. 1).

FIG. 14 shows a second embodiment in which the lower portion of the assembly (body 14 mounted within a base 16, supporting a droplet 10) is identical to that of FIG. 1, but wherein the upper portion has a different stop arrangement to intercept light on the direct path between the fiber 36 and droplet 10.

An inverted cylindrical cup 52 is mounted onto the fibre adjacent to the fibre's transmission surface 54. The mouth 56 of the cup is sealed by a quartz plate 58 having a central opaque stop 60 thereon. It will be appreciated that the operation of this embodiment is identical to that of FIG. 1, i.e. direct transmission of light is blocked but the quartz plate permits transmission of light around the stop along an indirect path 46 to be reflected by the silvered curved surface 20 of the body 14, thereby coupling light into the droplet 10.

FIG. 15 shows a third embodiment in which the plastic base is omitted and the geometry of the body 14 has been altered to account for a different incident geometry of light from above. However as with the body 14 of FIGS. 1-5, the same overall structure is present, in particular with the silvered, curved annular wall being shaped to reflect light into a droplet 10 from a fiber 60.

Mounted on the fibre 60 is a conical body 62 having an opaque external construction with internal silvered walls 64. The interior of this cone is substantially filled by a quartz plug 66 having a curved top surface 68 defining an upper quartz-air interface, and curved bottom surface 70 defining a lower quartz-air interface. (Rather than silvering, reflection can also be achieved by a suitable choice of refractive index materials for plug 66 and conical body 62, so that rays are redirected by total internal reflection. Alternatively, other redirecting elements such as lenses, or combinations of optical components serving to redirect the incident illumination, can be substituted.)

Curved top and bottom surfaces 68, 70 have radii which ensure that there is no refraction of light passing into or out of the plug 66, due to the light striking the interfaces normally. Two ray paths 72, 74 are shown in FIG. 15, with ray path 72 showing a ray which just hits the outer edge of silvered surface 20 and ray path 74 showing a ray which just hits the inner edge. Thus, it will be seen that all of the light which illuminates the silvered inner cone surface 64 from its lower edge 76 defined at the mouth of the cone up to the height indicated generally at 78, around the entire inner conical circumference, will be directed onto the silvered surface 20 and thereby indirectly into the droplet. The curved bottom surface 70 is interrupted by a central conical notch 80 which reflects light travelling directly from the source fiber 60 to the droplet 10, thereby acting as a stop.

In addition to the light rays 72, 74 arriving at the curved surface 20 by reflection from the silvered walls 64, there is a direct path also from the source fiber 60 to the curved surface 20 through the quartz plug 66. However, there is no direct path from the source fiber 60 to the droplet 10 due to the notch 80 reflecting light away from the droplet.

FIG. 16 shows a further embodiment which can be used without any special form of base. In FIG. 16, samples are provided as droplets 82 sitting on a surface 84. The surface could be a flat surface as shown, or the droplets could be disposed on a drop-supporting surface such as the base 14 (FIG. 1) or on e.g. a plate having multiple raised dropheads or dropheads defined by surface treatment to confine the liquid at a particular position. In the embodiment shown, the droplets have a high contact angle (e.g. due to aqueous drops on a hydrophobic surface or oily drops on a hydrophilic surface).

In the FIG. 16 embodiment a source fiber 86 and detector fiber 88 are provided in a parallel arrangement terminating in a hollow inverted cup-shaped body 90 having a reflective inner surface 92. The mouth 94 of the body is positioned above a droplet 82 and can be translated from one droplet to another for successive measurements, either manually or in an automated fashion.

Within the hollow interior 96 of the body 90 a stop 98 is mounted directly below the source fiber 86. The stop is opaque to the illumination radiation from the source, and thereby prevents a portion 100 of the source radiation from travelling directly into the droplet 82. However, another portion 102 of the source radiation can travel indirectly to the droplet by reflection from the walls 92 to cause a photoluminescent excitation, resulting in photoluminescent radiation 104 emanating from the droplet, some of which is captured in the open mouth 94 of the body and reaches the detector fiber directly (e.g. passing through the stop if the stop is transmissive of the wavelength of photoluminescent radiation, or bypassing the stop depending on the geometry of the fibers and stop) or indirectly by reflection from the walls 92.

While the embodiment of FIG. 16 shows light entering the droplet at oblique angles of e.g. 30-80 degrees, it will be appreciated that by appropriate design of the shape of the body 90, the geometry of the fibers and stop, and the position of the body relative to the droplet 82, the range of angles can be constrained to different values. It will be observed that the rotationally symmetric design of the body 90 causes radiation to enter the droplet from all sides.

FIG. 17 shows a further embodiment in which a source fiber 106 is located in a hollow body 108 having reflective walls 110, at least over a portion of the internal surface suitable to reflect source radiation 112 indirectly into the droplet 82 through a section 114 of an inverted conical notch positioned over the droplet, the section 114 being transparent to both the source radiation and to photoluminescent radiation generated by excitation from the source radiation.

A central portion 116 of the inverted conical notch is opaque to the source radiation and prevents direct transmission of light into the droplet and to a detector fiber 118 positioned below the surface 84 on which the droplet sits.

The embodiment of FIG. 17 is adapted for an automated analysis system, with the body 108 and source fiber 106, together with the detector fiber 118 being translatable together in a relative horizontal direction to the surface, and the body 108 being movable vertically between measurements. The surface 84 may be movable to provide this relative horizontal translation, or the body 108, source fiber 106 and detector fiber 118 may be movable (or a combination thereof).

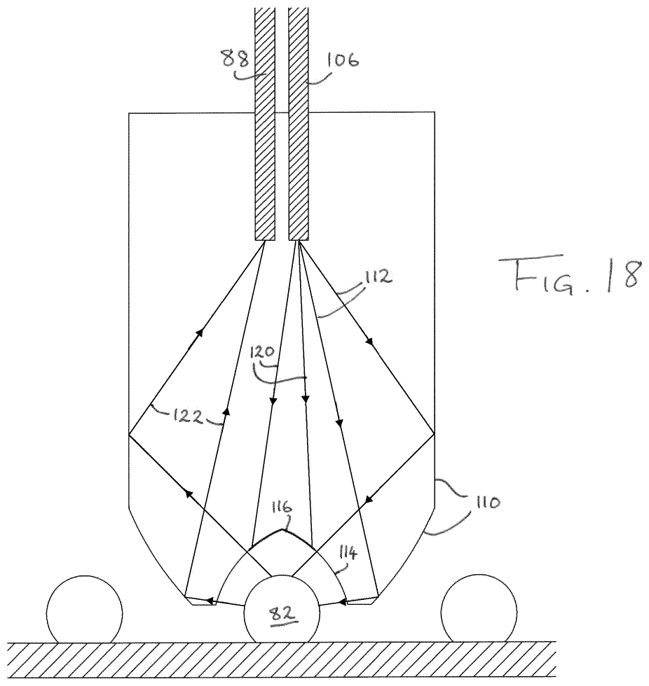

FIG. 18 shows an embodiment which is generally similar in configuration to FIG. 17 but wherein the detector fiber 88 is alongside the source fiber 106 at the top of the body 108. It can be seen from the ray tracings that some rays 112 from the source fiber reach the droplet 82 by reflection from the reflective wall sections 110, while other rays 120 are blocked by the opaque section 116, preventing direct (unreflected) illumination of the droplet. The photoluminescent radiation that is excited in the droplet is at least partly captured as rays 122 which travel to the detector fiber 88 by reflection. The opaque section 116 could be transparent to the wavelength of the photoluminescent radiation allowing a direct path up to the detector.

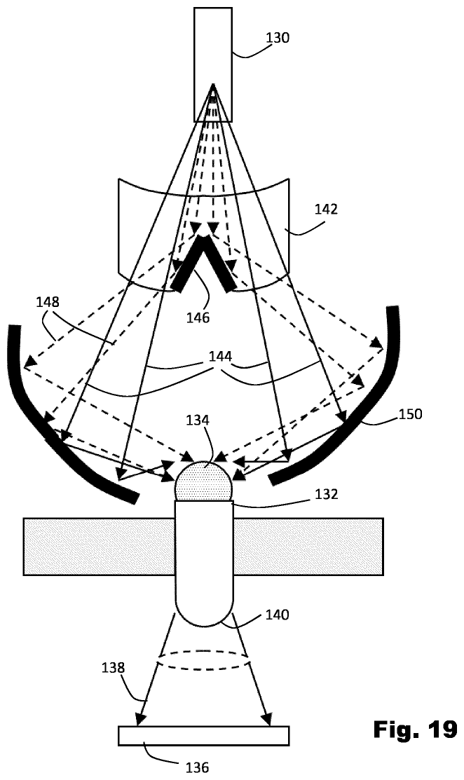

FIG. 19 shows an embodiment having a source fiber 130 positioned above a transparent (e.g. quartz) drop-supporting plinth 132 on which a droplet 134 is resting. A charge-coupled detector (CCD) 136 is positioned below the underside of the plinth to capture photoluminescent radiation 138 that has been excited in the droplet and transmitted through the plinth.

The underside of the plinth 140 is shown as having a lens shape to indicate that the emerging radiation can be shaped to focus as much as possible of the radiation on the CCD 136. It will be appreciated that other detectors could be used, including other solid-state detectors and optical fibers to capture the photoluminescent radiation.

Between the source fiber 130 and the droplet 134 a structure 142 allows a portion of the source radiation (the darker coloured rays 144) to pass through directly, with a central conical reflective notch 146 intercepting light (lighter coloured rays 148) that would otherwise travel directly from source fiber to droplet. The reflective notch 146 increases the amount of light indirectly reaching the droplet by obliquely reflecting the light into a reflector body 150.

The reflector body 150 is shaped to maximise the amount of light to be transmitted into the droplet including both the rays 144 that reach it without reflection from the notch 146 and those rays 148 that are reflected from the notch to the upper part of the reflector body. It will be appreciated that the precise shape can be calculated in a straightforward manner to optimise incident radiation once the desired geometry of the system or apparatus is known.

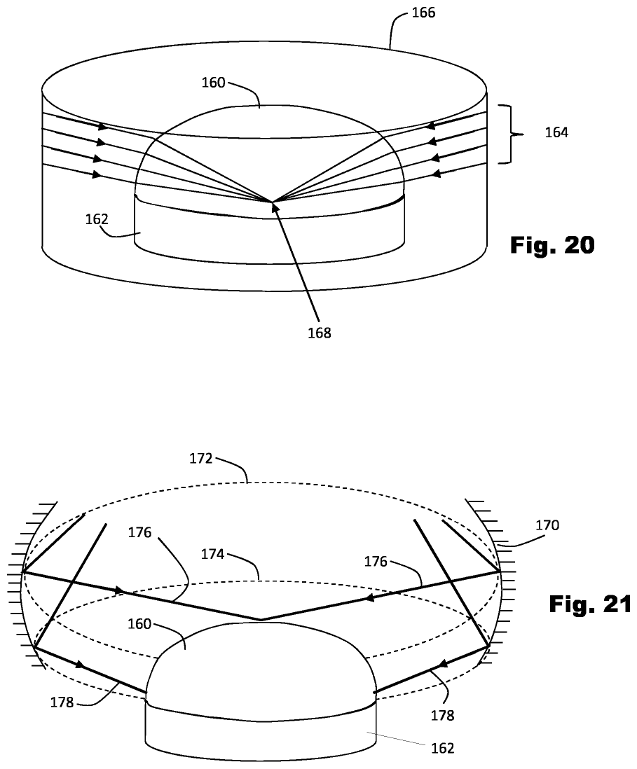

FIG. 20 illustrates a droplet 160 on a drop-supporting surface 162 receiving incident radiation 164 from all sides as indicated with the cylinder 166. The radiation, as in the previously described embodiments, is transmitted indirectly into the droplet from a redirecting element such as a refractive or reflective element substantially surrounding the cylindrical region radially. In FIG. 20, the incident radiation is focussed to a point 168.

FIG. 21 illustrates a similar set-up but with a different manner of focussing. The reflective element 170 is shown on either side, and the broken-line ellipses 172 and 174 denote upper and lower boundaries of a reflecting region of the reflective element between which radiation is reflected into the droplet as indicated by upper rays 176 and lower rays 178. Between the upper and lower rays there will also be intermediate rays (not shown) reflected into the droplet. Unlike the FIG. 20 embodiment, the incident radiation provides a whole-drop illumination with the illumination being diffused across the volume of the drop and not focussed into a single point-like sub-volume.

The FIG. 20 set-up provides for intensity maxima fluorescence and is optimised to obtain the best signal from samples that do not bleach, while the FIG. 21 set-up provides for full-drop fluorescence for samples that are liable to bleach when exposed to high local intensities.

By an appropriate choice of focussing optics, the system can be designed to generate either intensity maxima fluorescence or full-drop fluorescence. Furthermore, and advantageously, the same system can be switched from one mode to another by relative repositioning of the source, the reflective element and the sample, or focussing optics can be introduced between the source and the reflective element to alter the range of incident angles and thereby adjust the illumination pattern reaching the sample. It is further possible to have reflective walls that can be deformed or shaped selectively to change the illumination mode between a focussed and a diffuse illumination or anything in between. In this way the amount of photo-bleaching can be controlled.

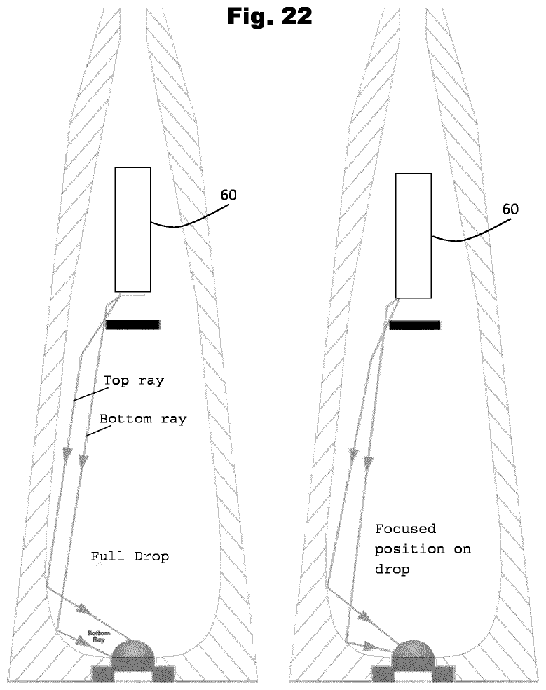

FIG. 22 shows one method of achieving this with a movable source fiber 60 whose vertical position can be shifted relative to the body so as to change the angles at which the light impinges on the reflective surface. In the left-hand image, the source fiber is slightly higher, resulting in a full drop illumination, while in the right-hand image the source fiber is slightly lower, resulting in a focussed illumination. 5. Instead of one fiber and one source, with movement of the fiber between “intensity” and “whole-volume” excitation, two or more fibers can be used with one, two or more sources. A simple alternative design to FIG. 22 could use two fixed fibers with two sources, each fiber terminating at a suitable position to ensure either full-drop or focussed illumination. The same could be achieved with two fibers connected via a fiber switch to a single source.

Other ways of controlling photo-bleaching can include controlling the duration and intensity of the illumination pulse and the duration of a relaxation period between pulses. Photo-bleaching can be removed in many cases by short pulsed signals with a long quiescent period with no signal allowing the molecular system to recover.

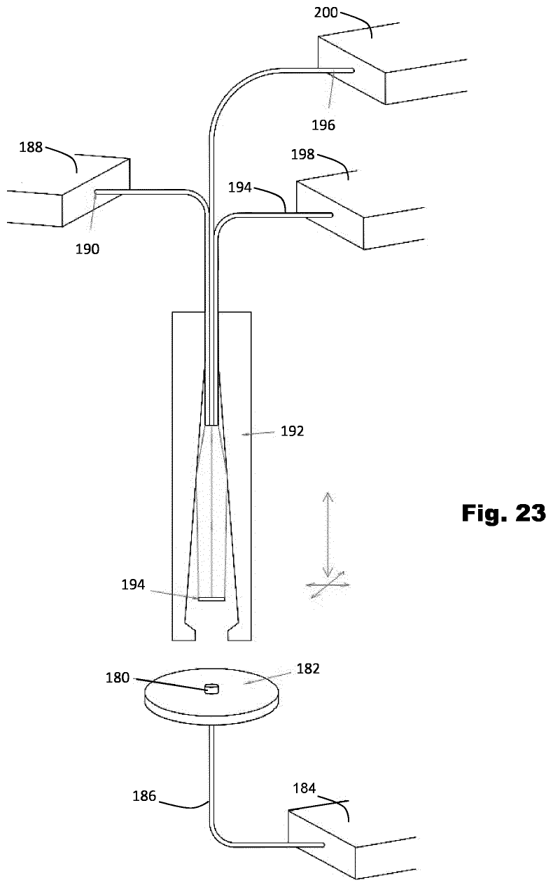

FIG. 23 shows a system having the ability to perform multiple types of analysis, including for example fluorescence and conventional spectroscopy. A drop-supporting surface 180 is mounted on a platform 182 to receive and hold a sample droplet thereon. A near infrared (NIR) source 184 is provided below the platform and illuminates the sample from below via a fiber 186. A NIR spectrometer 188 is provided with a fiber connection 190 to the top of a body member 192 positioned above the droplet.

Within the body member a stop 194 is disposed in the direct path between the sample and the fiber connection to the NIR spectrometer, but this stop is only selectively opaque to radiation of specific wavelengths, and is transparent to NIR wavelengths. Thus, the NIR source can illuminate the droplet and measurements of the transmitted radiation can be made by the NIR spectrometer.

Also at the top of the body member are two further fiber connections, similar to the configuration in FIGS. 16 and 18. One fiber 194 connects to a source 196 providing excitation radiation to excite fluorescence, while the other fiber 198 connects to a fluorescence spectrometer 200. As described in relation to earlier embodiments, the stop 194 prevents direct illumination from the source fiber 194 to the sample and the reflective inner walls of the body 192 cause the illumination to impinge on the droplet from all sides, with the induced fluorescence being transmitted directly up through the stop to the detector fiber 196.

The body 192 is movable by an automated raster scan in the X-Y directions and in the Z-direction, allowing the focal point of the radiation to be moved to obtain a maximum signal, and to move the body 192 between measurements from the raised position (shown) wherein the sample can be loaded onto and cleaned from the platform, and a lowered position with the droplet at the focal point of the illumination radiation.

A camera (not shown) measures the droplet volume for use in performing calculations of the analyte concentration. This can optionally be done according to the method described in WO2016/059131 A1, the contents of which are incorporated by reference as regards the use of a camera to measure dimensional parameters and to derive from these and the detected intensity an absorption coefficient and/or a turbidity coefficient.

The system of FIG. 23 can be switched to other types of spectroscopy due to the use of fiber connectors which allow sources and spectrometers to be switched in and out according to the desired measurements to be made. Thus, while a NIR source and spectrometer are illustrated, other wavelength sources and other types of detectors and analysers can be substituted. Similarly, while a fluorescence source and spectrometer are illustrated, phosphorescent and Raman sources and detectors/spectrometers can equally be used.

The invention is not limited to the embodiment(s) described herein but can be amended or modified without departing from the scope of the present invention.

1. A system for measuring photoluminescence in a droplet, comprising:
a source of light for exciting photoluminescence in a liquid, said source being located at a first position;
a stop positioned relative to said source so as to define a shadow zone in which light of at least one wavelength emanating from said source is blocked from direct transmission by the stop, said shadow zone including a sample-receiving region;
a redirection system comprising at least one redirecting element positioned outside said shadow zone, wherein said at least one redirecting element is adapted to receive light from said source and to redirect said received light towards the sample-receiving region inside said shadow zone; and
a detector receiving, at a second position, photoluminescent radiation emanating from the sample-receiving region; and
wherein said redirection system extends around said shadow zone to redirect light into the sample-receiving region from a plurality of converging directions, such that the sample-receiving region receives light from said plurality of converging directions.

2. A system according to claim 1, wherein said plurality of converging directions encompass in aggregate a combined angular extent of at least 90 degrees, and preferably at least 180 degrees.

3. A system according to claim 1, wherein said redirection system includes one or more redirecting elements that are disposed on substantially all sides of said shadow zone, and which illuminate the sample-receiving region from substantially all sides simultaneously.

4. A system according to claim 1, wherein said at least one redirecting element is a reflective surface.

5. A system according to claim 1, wherein said at least one redirecting element is a refractive element.

6. A system according to claim 1, further comprising a drop-supporting surface located at the sample-receiving region, said drop-supporting surface being adapted to receive and retain thereon a sample in the form of a liquid drop.

7. A system according to claim 1, wherein the detector is shielded from direct illumination by said source.

8. A system according to claim 7, wherein the detector is shielded due to the second position being in said shadow zone.

9. A system according to claim 7, wherein the detector is shielded due to receiving illumination via a wave guide which receives light at the second position from a predetermined range of angles, wherein said source is not in a direct line of sight within said range of angles.

10. A system according to claim 9, wherein the wave guide is an optical fiber.

11. A system according to claim 1, wherein said source, the sample-receiving region and the stop are located along a common axis with the stop being located between said source and the sample-receiving region.

12. A system according to claim 11, wherein the second position is located along said common axis with the sample-receiving region being located between the second position and the stop.

13. A system according to claim 1, wherein the second position is between the stop and the sample-receiving region.

14. A system according to claim 13, wherein the second position is directly behind the stop and in the shadow thereof.

15. A system according to claim 1, wherein the detector is shielded against illumination by light from said source both along a direct path and along an indirect path via the redirection system.

16. A system according to claim 11, wherein the stop and the redirection system constrain the light travelling between the first position and the sample-receiving region to an indirect path and cause light to enter the sample-receiving region at a non-zero angle to said axis, thereby preventing the direct transmission of light from said source to the detector via the droplet.

17. A system according to claim 16, wherein the light is caused to enter the sample-receiving region at an angle of more than 45 degrees to said axis.

18. A system according to claim 17, wherein the light is caused to enter the sample-receiving region at an angle of between 70 and 110 degrees to said axis.

19. A system according to claim 16, wherein the light is caused to enter the sample-receiving region at said non-zero angle to said axis from a range of different lateral directions around said axis, and preferably from substantially all lateral directions simultaneously.

20. A system according to claim 1, wherein said redirection system is adapted to focus the incident light at the sample-receiving region in a concentrated focus within the volume of a sample, whereby relative movement of one or more of the sample, the redirection system, said source, or an optical element located in an indirect path between said source and the sample via the redirection system, causes the concentrated focus to move within the sample to optimise the photoluminescent signal from the sample.

21. A system according to claim 20, wherein said redirection system is adapted to focus the incident light such that at the sample-receiving region the incident light is spread across a diffuse focus area intersecting the majority of the sample volume.

22. A system according to claim 21, wherein relative movement between said source and the redirection system, or the adjustment of an optical element in the path of the incident light, causes the focus to switch from a concentrated focus to a diffuse focus.

23. A system according to claim 21, wherein the redirection system is configurable between a first configuration providing a concentrated focus and a second configuration providing a diffuse focus.

24. A system according to claim 21, wherein activation of a second source, at a different position relative to the redirection system than said source, causes the focus to switch between a diffuse focus and a concentrated focus.

25. A system according to claim 24, further comprising one or more further sources, located at different position(s) than said source or said second source, which when activated cause the focus to switch to one of a concentrated focus in a different position within the sample-receiving region and a diffuse focus with different spatial characteristics than provided by either said source or said second source.

26. A system according to claim 1, wherein the redirection system in combination with said source or sources of light is effective to bring the incident light to a focus that is intermediate between a concentrated point-like focus and a diffuse focus extending through the volume of a sample at the sample-receiving region.

27. A system according to claim 1, further comprising a sample-receiving surface for receiving a sample at the sample-receiving region; a positioning system for controllably causing relative movement between one or more of the sample-receiving surface, the redirection system, said source, and an optical element in the path of the incident light; and a controller for operating the positioning system to achieve a desired focussing of the incident light at the sample-receiving region.

28. A system according to any claim 27, wherein said controller receives as an input a signal from the detector, whereby an optimal position may be identified according to the characteristics of the detector signal.

29. A system according to claim 1, further comprising an imaging system for imaging the sample-receiving region.

30. A system according to claim 29, wherein said imaging system comprises a camera.

31. A system according to claim 29, wherein said imaging system is provided with protection against overexposure from said source.

32. A system according to claim 31, wherein said protection is selected from a filter that attenuates light of a wavelength emitted by said source and an electronically controlled shutter that is timed to the excitation of said source.

33. A system according to claim 29, further comprising a computerised system programmed to calculate, from an image provided by the imaging system, one or more dimensional characteristics of the sample, and to normalise a photoluminescence measurement according to the said one or more dimensional characteristics and a signal from the detector.

34. A system according to claim 1, further comprising a support body having a hollow cavity having an opening and having said at least one redirecting element on the interior thereof, said source being mounted in said cavity to illuminate said at least one redirecting element and said stop being mounted internally of said cavity to block at least a portion of the light from said source from travelling towards the opening, whereby a sample may be introduced at or within the opening to receive redirected illumination from said at least one redirecting element.

35. A system according to claim 1, further comprising a support base having a sample-receiving surface defined thereon within said shadow zone, and having said at least one redirecting element of said redirection system provided as a circumferential redirecting element at least partially surrounding the sample-receiving surface, wherein said circumferential redirecting element is shaped to redirect light received from said source to a sample-receiving region adjacent the sample-receiving surface, such that when a sample in the form of a drop is placed on the sample-receiving surface it is illuminated with said redirected light.

36. A system according to claim 1, wherein frequency characteristics of the illumination from source or sources of light are controllable.

37. A system according to claim 36, wherein the frequency characteristics can be controlled to vary the photoluminescent response of different species in a sample.

38. A system according to claim 36 or 37, wherein said source comprises a plurality of sources each with different frequency characteristics, which may be activated and deactivated independently, or mixed together, or activated with different intensities.
